(19) United States
(12) Patent Application Publication
(10) Pub. No.: US 2009/0211377 A1
(43) Pub. Date: Aug. 27, 2009

(54) Force sensors

(75) Inventor: Neal Blundred, Denbighshire (GB)

Correspondence Address: CHARLES N. QUINN;FOX ROTHSCHILD LLP, 2000 MARKET STREET, 10TH FLOOR, PHILADELPHIA, PA, 19103, US

(73) Assignee: Zi Medical PLC, St. Asaph, Denbighshire (GB)

(21) Appl. No.: 11/887,022

(22) PCT Filed: Mar. 24, 2006
(86) PCT No.: PCT/GB2006/001109

§ 371 Date: Oct. 24, 2008

(30) Foreign Application Priority Data
Mar. 24, 2005 (GB) 0506081.9

(51) Int. Cl. G01L 1/22

(52) U.S. Cl. 73/862.627

(57) ABSTRACT

A management system for a force sensor, such as a QTC force sensor, comprising a first part (4) and a second part (6), and at least one resiliently deformable member (12) for at least partially surrounding the QTC material provided between said first and second parts.

The present invention relates to force sensors, in particular to quantum tunnelling composite (QTC) force sensors.

Force or load sensors are used to measure loads/weights/forces. Conventionally, such sensors have been strain gauge based sensors that measure the change in resistivity of a slender foil in response to an applied load or piezo resistive sensors that measure the change in resistance or current output of a piezoelectric crystal in response to applied loads. However, such sensors are not always suitable for applications such as robotics, medical equipment or car seat sensors due to their poor flexibility.

QTC force sensors, such as that sold by Peratech, have been developed to overcome some of the problems encountered with the prior art force sensors. QTC is a material that has semi-conductive particles disposed in a non-conductive matrix with the spacing of the particles being sufficiently close that electron tunnelling can occur when an electrical potential is applied across the material. Compression of the material may cause the particles to move closer together, thereby increasing the probability of electron tunnelling events (which is inversely dependent on the particle spacing) and reducing the effective resistance of the material. Thus, when pressure is applied to the material, its resistance starts to drop in a smooth, predictable way. Furthermore, its particular construction allows it to cycle over a million times between the insulator and conductor state.

QTC sensors provide a number of advantages over the prior art sensors. They are flexible and can be constructed in virtually any size and shape. They can also be constructed with no air gap such that they can be provided in a totally sealed environment. Furthermore, the sensors have improved reproducibility and an enhanced sensing range.

However, one drawback associated with QTC sensors is that their high sensitivity means that the material should not be exposed to too great a load. Additionally, it is important to provide an environment whereby the material can return to its normal, pre-compressed state.

It is an object of the present invention to provide a QTC force sensor that aims to overcome or at least alleviate the abovementioned drawbacks.

A further object of the present invention is to provide a management system for a QTC force sensor.

Accordingly, a first aspect of the present invention provides a QTC force sensor comprising a first part and a second part, a QTC material positioned between said first and second parts and at least one resiliently deformable member at least partially surrounding the QTC material between said first and second parts.

In this manner, force can be applied to the first or second part which compresses the member surrounding the QTC material thereby reducing the load to which the QTC material is exposed. Removal of the force allows the members to recover.

In one embodiment, the member comprises one or more side walls extending from the first or second part, the side walls being adopted to splay apart upon application of force thereto. Preferably, the first part comprises a roof with side walls extending therefrom for forming the resiliently deformable member and the second part forms an abutment for the side walls.

To this end, a preferred embodiment of the invention comprises a QTC force sensor comprising a housing having a first part and a second part, a QTC material positioned between said first and second parts, the first part forming a roof with side walls extending therefrom and the second part forming an abutment member for the side walls, wherein the side walls are adapted to splay apart upon application of a force thereto.

A second aspect of the present invention provides a management system for a QTC force sensor, the system comprising a kit of parts having a first part, a second part and a resiliently deformable member for locating between said first and second parts.

One management system according to the second aspect of the present invention comprises a housing having a first part and a second part, the first part forming a roof with side walls extending therefrom and the second part forming an abutment member for the side walls, wherein the side walls are adapted to splay apart upon application of a force thereto.

Preferably, the abutment member has a chamfered or bevelled edge over which the side walls may splay apart.

In a preferred embodiment of the present invention, the housing is cylindrical with the second part being in the form of a disc with a bevelled edge. More preferably, the side walls of the first part are relieved of material at spaced apart intervals to provide a plurality of legs extending from the roof of the first part.

It is preferable for the diameter of the roof section to be slightly less than that of the disc whereby the end of the legs abut the inner edge of the bevelled edge in the non-compressed or partially compressed state but splay apart to abut the outer edge of the disc in the fully compressed state.

The housing may be made of any suitable material provided that the side walls of the first part are able to splay apart upon application of a predetermined amount of pressure thereto. Preferably, the housing is formed of an acetyl material.

In an alternative embodiment of the first and second aspects of the present invention, the first and second parts may be in the form of plates having a elastomeric material (such as a rubber or elastomeric pad) provided therebetween that at least partially surrounds the QTC material in the assembled system. The member may comprise two pads for surrounding each half of the QTC material. More preferably, the QTC material is in contact with at least one intermediate member between it and the first or second part The intermediate member may comprise, for example, a rubber ring or disc. The ring or disc may be formed of the same material as the resiliently deformable member or, more preferably, is more flexible (i.e. less rigid) than the member.

It is to be appreciated that at least one part is fixed in position. Preferably, the second part is fixed in position.

Means for transmitting the signal from the sensor preferably provided between the first and second parts, for example in the form of a flexible printed circuit board.

It is preferable to provide two discs of QTC material between the first and second parts, more preferably being separated by a silicon wafer. Each QTC disc may contact a flexible printed circuit board (PCB). Alternatively, the PCB may be provided between the discs of QTC material. The flexible PCB is preferably provided with limbs that extend therefrom, for example between the legs of the housing for carrying connectors to a control unit.

Further means may be provided on the inner or outer sides of the first and/or second parts to aid the transfer of force from outside the management system to inside the system, such as one or more rubber rings. The rings may or my not be of the same material as the resiliently deformable member.

In a preferred embodiment of the present invention, the managed sensor is used for sensing the linear stress in a drive shaft. In this embodiment, the first and second parts, for example in the form of a housing, and the sensor should be mounted with respect to the shaft.

To this end, a third aspect of the present invention provides a drive shaft provided with a QTC force sensor comprising a first and second part mounted with respect to the shaft, a QTC material positioned between said first and second parts and at least one resiliently deformable member at least partially surrounding the QTC material between said first and second parts.

Preferably, a bore is provided through the first and second parts for receiving the shaft. Preferably, the first part is provided with a cylindrical coupling for mating with a threaded coupling extending from the centre of the second part. The threaded coupling may receive a nut for abutment against the sensor.

The opposing side of the second part is preferably provided with a hollow cylindrical rod for its attachment to the shaft.

It is to be appreciated that the shaft should be provided with a flange for introducing force to the first part. Compensatory means may be provided between the first part and the flange to compensate for any geometrical inaccuracy of the shaft.

In a preferred embodiment of the present invention, the drive shaft forms part of a syringe driver assembly.

For a better understanding of the present invention and to show more clearly how it may be carried into effect, reference will now be made by way of example only, to the accompanying drawings in which:

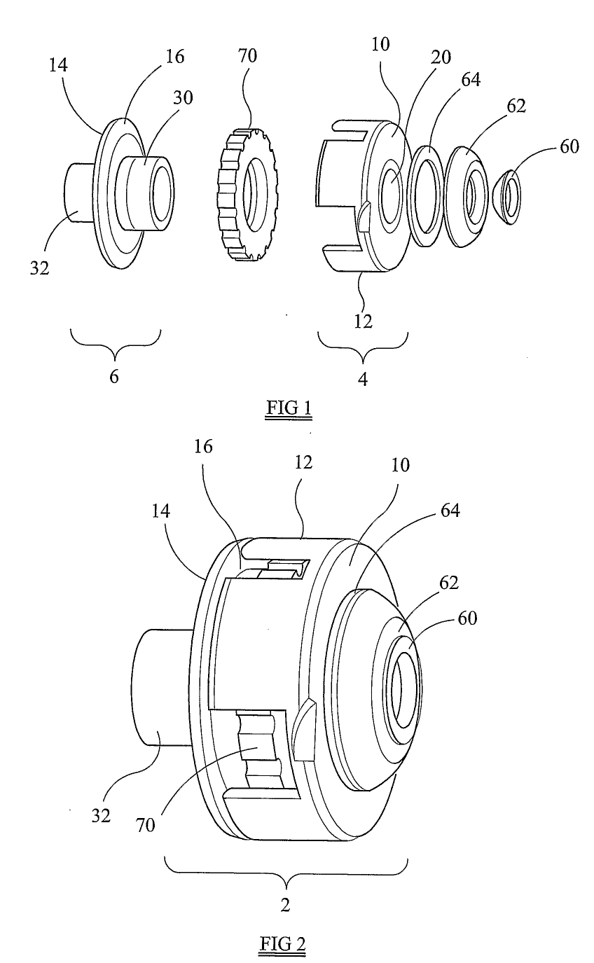

FIG. 1 is an exploded side perspective view of a force sensor management system according to a first embodiment of the present invention;

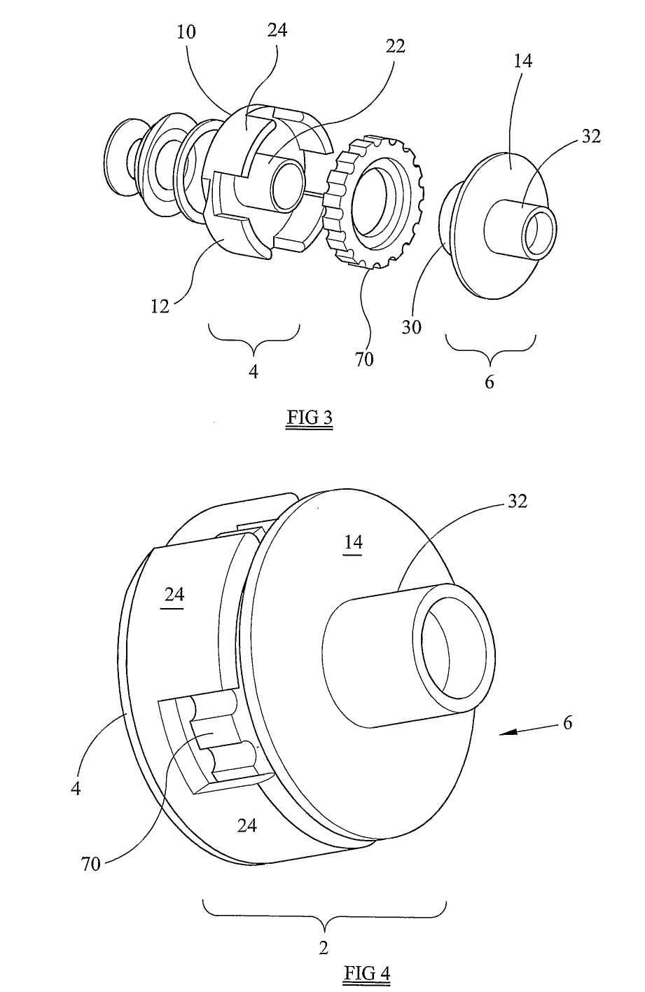

FIG. 2 is a side perspective view of the force sensor management system shown in FIG. 1;

FIG. 3 is an exploded rear perspective view of the force sensor management system shown in FIGS. 1 and 2;

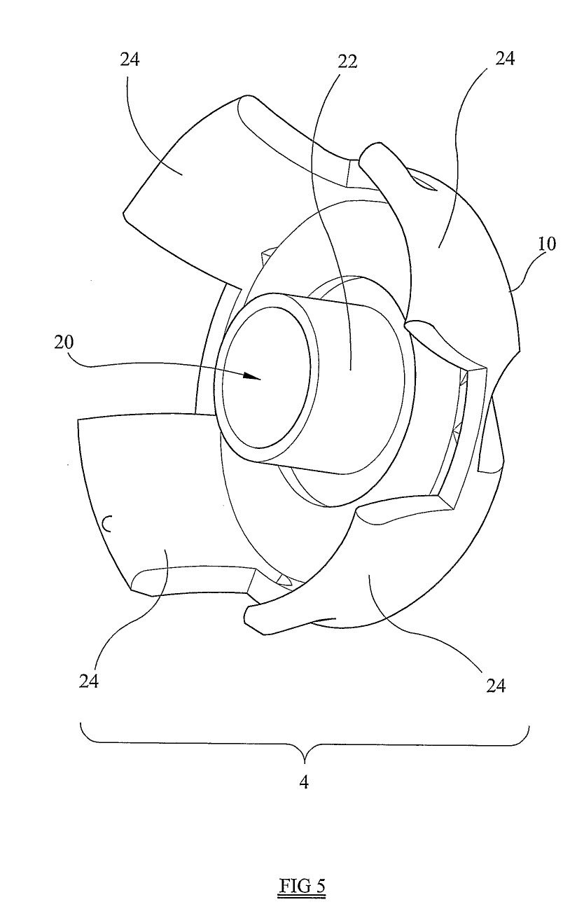

FIG. 4 is a rear perspective view of the force sensor management system shown in FIGS. 1, 2 and 3;

FIG. 5 is a perspective view of a sprung activator for a force sensor management system according to a first embodiment of the present invention;

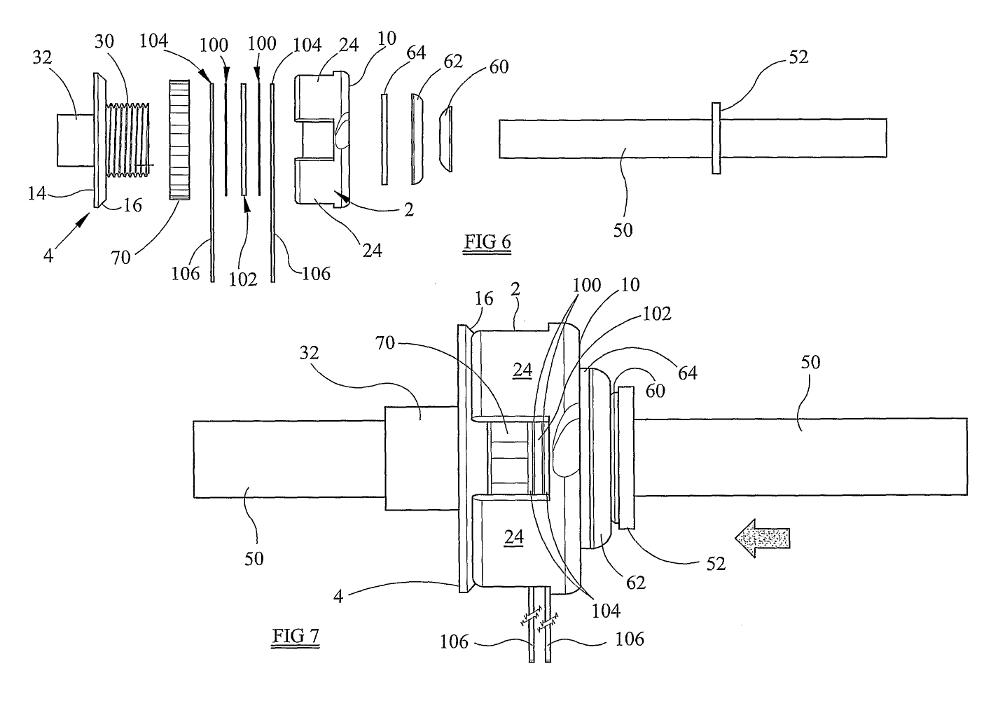

FIG. 6 is an exploded view a QTC force sensor according to the first embodiment of the present invention;

FIG. 7 is a side perspective view of the QTC force sensor shown in FIG. 6;

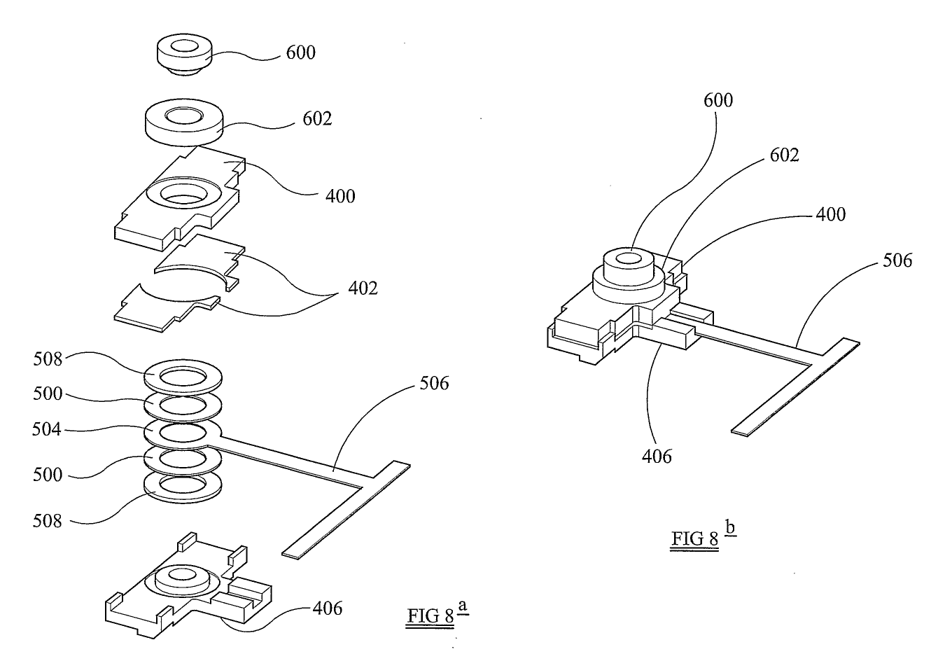

FIG. 8a is an exploded view of a QTC force sensor according to a second embodiment of the present invention; and

FIG. 8b is a perspective view of the force sensor of FIG. 8a, shown fully assembled.

Referring to the accompanying drawings, a force sensor management system according to one embodiment of the present invention is illustrated. FIGS. 1 to 5 illustrate the components of the management system of the invention and FIGS. 6 and 7 illustrate the incorporation of a QTC force sensor within the management system.

In its most basic form, the system comprises a housing for receiving the sensing means, the housing 2 having a first part 4 comprising a roof 10 with depending side walls 12 extending substantially perpendicularly from the roof and a second part 6 in the form of an abutment member 14 that contacts the edges of the side walls to form a closed housing within which the sensing means is held (not present in FIGS. 1 to 5). The edge of the abutment member has a bevelled or chamfered surface 16 and the side walls of the first part are constructed such that they may splay apart along the bevelled edge of the member upon application of force to the housing (see FIG. 5).

In the illustrated embodiments the management system is adapted for use in relation to motor-driven shaft 50 to sense the linear stress in the drive shaft which will be proportional to the force exerted by an exerting means driven by the shaft For example, such an arrangement may be provided in a syringe driver assembly where the exerting means may be a pad arranged to abut or press against a syringe plunger to expel fluid from a syringe.

The first part 4 of the housing is comprised of an acetyl material and has a cylindrical roof section 10 with a bore 20 running through the centre thereof, the bore extending inwardly to form a cylindrical coupling flange 22. The side walls of the first part are relieved of material at spaced apart intervals to form four legs 24. The second part 6 of the housing is in the form of a disc 14 having a cylindrical threaded coupling 30 extending from one side thereof and a cylindrical coupling flange 32 of substantially the same diameter as the cylindrical coupling flange 22 of the first part extending in the opposite direction. The diameter of the disc 14 is slightly larger than the diameter of the roof 10 such that the leading edges of the legs 24 abut the inner edge of the bevelled surface 16 of the disc in the non-compressed state. The cylindrical flange coupling 22 of the first part 4 mates with the threaded coupling 30 of the second part and the shaft 50 passes through the bore that extends through the centre of the housing. A flange 52 is provided on the shaft for introducing force to the roof 10 of the first part. The second part 6 is fixed in position on the shaft by suitable means.

In this manner, force that is applied by the shaft 50 causes the first part 4 of the housing to press against the disc 14 which results in the legs of the first part being splayed apart over the bevelled surface 16 of the disc. This movement is detected by the sensor placed within the housing which can be used determine the force applied. When force is removed, the first part of the housing acts as a spring and returns to its original, non-compressed (or partially compressed) state.

Additionally, further components may be provided to compensate for any geometrical inaccuracy in the shaft. In a preferred embodiment, a spherical pusher 60 and socket 62 are provided in contact with the flange 52 of the shaft and an X Y compensator 64 is provided between the roof 10 and the socket 62.

FIGS. 6 and 7 of the accompanying drawings illustrate in detail the installation of a QTC sensor 100 within the management system shown in FIGS. 1 to 5. Two discs of QTC material 100, such as the proprietary material Peratech™ switch substrate material, are provided within the housing, having a silicon wafer 102 sandwiched therebetween. A flexible printed circuit board (flexi PCB) 104 is placed next to each QTC disc, having limbs 106 carrying wires to a control circuit (not shown), the limbs passing between the legs 24 of the first part 4 of the housing.

A nut 70 is threaded onto the threaded coupling 30 of the second part to act as a back stop against which the QTC sandwich is compressed and to pre-compress the material to a desirable condition (i.e. desired electronic output).

The management system of the present invention for housing a QTC sensor acts to reduce the amount of load (i.e compression) to which it is exposed. As force is applied, the housing reduces and controls how much the QTC material is compressed. The first part of the housing acts as a sprung activator with the force encountered by the QTC material being proportional to the actual force transmitted by the shaft.

Whilst the management system has been shown in relation to a sensor for detecting the force exerted by a motor driven shaft, it is to be appreciated that it could be adapted for use with any sensor, in particular a QTC force sensor, for a wide range of applications, such as robotics, bathroom scales, fitness equipment and car seat occupancy detection for airbag control.

A significant advantage of the present invention is that the management system for the QTC sensor may be manufactured in bulk for a relatively small cost (approximately 100 times cheaper than management systems developed prior hereto).

FIGS. 8a and 8b of the accompanying drawings illustrate an alternative embodiment of the present invention wherein the housing is replaced with a front plate 400 rubber pads 402 and a back plate 406, each having a central bore therethrough for passage of a shaft (not shown) therethrough. A flexible printed circuit board 504 is sandwiched between two rings or discs of QTC material 500 which are sandwiched between rubber rings 508 that contact the front and back plates. The flexi-PCB has a limb 506 carrying wires to a control circuit (not shown). The rubber rings, QTC discs and flexi PCB are surrounded by the rubber pads 402 that contact the front and back plates 400, 406, thereby acting as a force sensor management system for the QTC force sensor contained therewithin. A conical pusher 600 and thrust bearing 602 are provided in contact with the shaft to compensate for any geometrical inaccuracy in the shaft.

The second embodiment of the present invention may allow for reduced manufacturing costs and a reduction in noise from the shaft.

The material of the rubber pads and ring may be the same or different. The difference in pad and ring area is used to produce the force/pressure reduction to the QTC material, increasing the range to 6 kg. However, it may be appropriate to use rubbers with different stiffness properties to get the same effect, for example pad rubber stiffness=X, ring rubber stiffness=X/2. This may allow for a reduction in the size of the sensor.

1-24. (canceled)

25. A management system for a force sensor, the system comprising a housing having a first part and a second part for receiving a force sensor therebetween, the first part forming a roof with side walls extending therefrom and the second part forming an abutment member having a chamfered or bevelled edge over which the side walls of the first part may splay apart upon application of a force thereto.

26. A management system as claimed in claim 25 wherein the housing is cylindrical with the second part being in the form of a disc with a chamfered or bevelled edge.

27. A management system as claimed in claim 26 wherein the side walls of the first part are relieved of material at spaced apart intervals to provide a plurality of legs extending from the roof of the first part.

28. A management system as claimed in claim 27 wherein the diameter of the roof is slightly less than that of the second part whereby the end of the side walls abut the inner edge of the bevelled edge in the non-compressed or partially compressed state but splay apart to abut the outer edge of the second part in the fully compressed state.

29. A management system as claimed in claim 28 wherein the force sensor is provided within the housing.

30. A management system as claimed in claim 29 wherein the force sensor comprises a QTC material.

31. A management system for a force sensor as claimed in claim 30 wherein at least one part is fixed in position.

32. A management system as claimed in claim 31 wherein the second part is fixed in position.

33. A management system as claimed in claim 32 wherein the housing is of an acetyl material.

34. A management system as claimed in claim 33 wherein means for transmitting the signal from the force sensor is provided within the housing.

35. A management system as claimed in claim 34 wherein the signal transmission means is in the form of a flexible printed circuit board.

36. A management system as claimed in claim 35 wherein two discs of QTC material are provided within the housing.

37. A management system as claimed in claim 36 wherein each disc is separated by a silicon wafer.

38. A management system as claimed in claim 37 wherein each QTC disc contacts a flexible printed circuit board (PCB).

39. A management system as claimed in claim 38 wherein each flexible PCB is provided with limbs that extend between the legs of the housing for carrying connectors to a control unit.

40. A management system as claimed in claim 39 wherein further means is provided on the inner or outer sides of the housing to aid transfer of force from outside the housing to inside the housing.

41. A QTC force sensor comprising a housing having a first part and a second part, a QTC material positioned between said first and second parts, the first part forming a roof with side walls extending therefrom and the second part forming an abutment member having a chamfered or bevelled edge over which the side walls of the first part may splay apart upon application of a force thereto.

42. A QTC force sensor as claimed in claim 41 that senses linear stress in a drive shaft.

43. A QTC force sensor as claimed in claim 42 wherein the housing and sensor is mounted with respect to the shaft.

44. A QTC force sensor as claimed in claim 42 wherein the first part of the housing is provided with a cylindrical coupling for receiving the shaft and for mating with a threaded coupling extending from the centre of the second part.

45. A QTC force sensor as claimed in claim 43 wherein the threaded coupling receives a nut for abutment against the sensor.

46. A QTC force sensor as claimed in claim 44 wherein the opposing side of the second part is provided with a cylindrical rod for its attachment to the shaft.

47. A QTC force sensor as claimed in claim 45 wherein shaft is provided with a flange for introducing force to the roof of the first part.

48. A QTC force sensor as claimed in claim 46 wherein compensatory means is provided between the roof and the flange to compensate for any geometrical inaccuracy of the shaft.
